(19) United States
(12) Patent Application Publication
(10) Pub. No.: US 2021/0247638 A1
(43) Pub. Date: Aug. 12, 2021

(54) SMART FILM APPARATUS

(71) Applicants: POLYTRON TECHNOLOGIES, INC., Taoyuan City (TW); POLYTRONIX, INC

(72) Inventors: Hong Zong LIAO, TAOYUAN CITY (TW); Ta Jung CHENG, TAOYUAN CITY (TW); Cheng I CHEN, TAOYUAN CITY (TW); Li Hua CHU, TAOYUAN CITY (TW)

(21) Appl. No.: 16/951,415

(22) Filed: Nov. 18, 2020

(30) Foreign Application Priority Data
Feb. 7, 2020 (TW) 109103863
Mar. 10, 2020 (TW) 109202680

(51) Int. Cl. G02F 1/133; G02F 1/1334; G02F 1/1343

(52) U.S. Cl. CPC G02F 1/13306; G02F 1/1334; G02F 2202/28; G02F 1/13345; G02F 1/13439

(57) ABSTRACT

A smart film apparatus includes a smart film and a control member. The smart film includes a polymer dispersed liquid crystal or a polymer network dispersed liquid crystal between two conductive layers. Plural electrodes are formed on a single surface of one of the conductive layers, and it is easier to process. Two conductive layers that respectively include multitudes electrically isolated conductive units. With floating or ground controlling signal, the control member controls the conductive units to perform a variety of displaying effects. Moreover, the surface opposed to the single surface with electrodes is evenly flat with paste and beneficial to apply to desired target surface.

### 1. FIELD OF THE INVENTION

The present invention relates to applications of a dispersed liquid crystal film in display device, particularly to a liquid crystal-based smart film apparatus.

### 2. DESCRIPTION OF THE PRIOR ART

The liquid crystal light-regulation film is an optical film made of a polymer dispersed liquid crystal, electrically controlled to present a macroscopic effect light transmission or light scattering. Please refer to a Taiwan patent TWM 519749 for the application of the liquid crystal light-regulation film in ordinary window curtains. The liquid crystal light-regulation film is fabricated in a dry or wet process and applicable to different fields.

### SUMMARY OF THE INVENTION

A smart film apparatus is provided herein, wherein floating or grounding control signals are used to control a polymer dispersed liquid crystal-based smart film, whereby to achieve an effect of an opaque subject and a transparent background outside the subject.

A smart film apparatus is provided herein, wherein electrodes are disposed and exposed on a single surface of one of two conductive layers, and wherein the opposite surface is a flat plane allowing an adhesive membrane to be fixedly installed on, whereby the present invention can simplify the fabrication process and favor application of adhesive smart films.

A smart film apparatus, comprising: a smart film including a first conductive layer, a second conductive layer and a dispersed liquid crystal layer disposed between the first conductive layer and the second conductive layer, the first conductive layer and the second conductive layer including multitude of conductive units electrically isolated from each other, wherein there are a plurality of electrodes are exposed on a single surface of the first conductive layer or the second conductive layer, and the electrodes are fixedly on a portion of the conductive units; and a control member electrically connected to the electrodes and outputting multitude of control signals for controlling the first conductive layer or the second conductive layer where the electrodes are, and the control signals include at least one floating or grounding control signal.

A smart film apparatus, comprising: a smart film including a first conductive layer, a second conductive layer and a dispersed liquid crystal layer disposed between the first conductive layer and the second conductive layer, the first conductive layer including a plurality of first conductive units electrically isolated from each other, the second conductive layer including a plurality of second conductive units electrically isolated from each ether; and a control member electrically connected with the first conductive layer and the second conductive layer and outputting a plurality of control signals for controlling the first conductive units and the second conductive units, wherein the control signals at least includes a floating or grounding control signal to make the smart film present an opaque first display unit and a transparent second display unit adjacent to the first display unit.

### BRIEF DESCRIPTION OF THE DRAWINGS

FIG. 1 is a block diagram schematically showing a smart film apparatus according to one embodiment of the present invention.

FIG. 2 is a sectional view schematically showing a smart film of a smart film apparatus according to one embodiment of the present invention.

FIG. 3 is a top view schematically showing a second conductive layer of a smart film apparatus according to a first embodiment of the present invention.

FIG. 4 is a top view schematically showing a first conductive layer of a smart film apparatus according to the first embodiment of the present invention.

FIG. 5 is a perspective schematically showing a smart film apparatus according to one embodiment of the present invention.

FIG. 6 is a top view schematically showing a second conductive layer of a smart film apparatus according to a second embodiment of the present invention.

FIG. 7 is a top view schematically showing a first conductive layer of a smart film apparatus according to the second embodiment of the present invention.

FIG. 8 is a top view schematically showing a second conductive layer of a smart film apparatus according to a third embodiment of the present invention.

FIG. 9 is a top view schematically showing a first conductive layer of a smart film apparatus according to the third embodiment of the present invention.

FIG. 10 is a diagram schematically showing a first example of presentation of a smart film apparatus according to one embodiment of the present invention.

FIG. 11 is a top view schematically showing a first conductive layer of a smart film apparatus according to a fourth embodiment of the present invention.

FIG. 12 is a top view schematically showing a second conductive layer of a smart film apparatus according to the fourth embodiment of the present invention.

FIG. 13 is a top view schematically showing a first conductive layer of a smart film apparatus according to a fifth embodiment of the present invention.

FIG. 14 is a top view schematically showing a second conductive layer of a smart film apparatus according to the fifth embodiment of the present invention.

FIG. 15 is a diagram schematically showing a first example of presentation of a smart film apparatus according to the fifth embodiment of the present invention.

FIG. 16 is a diagram schematically showing a second example of presentation of a smart film apparatus according to the fifth embodiment of the present invention.

FIG. 17 is a diagram schematically showing a third example of presentation of a smart film apparatus according to the fifth embodiment of the present invention.

FIG. 18 is a top view schematically showing a first conductive layer of a smart film apparatus according to a sixth embodiment of the present invention.

FIG. 19 is a top view schematically showing a second conductive layer of a smart film apparatus according to the sixth embodiment of the present invention.

FIG. 20 is a diagram schematically showing a first example of presentation of a smart film apparatus according to the sixth embodiment of the present invention.

### DESCRIPTION OF THE PREFERRED EMBODIMENT

The adhesive smart film of the present invention may be applied to many display devices, presentation devices, or display-presentation devices. The present invention may be, for example but not limited to be, applied to walls or windows of buildings, interior windows, interior partitions, interior decorations, vehicular smart windows, liquid crystal display devices, suspended particle display devices, bistable liquid crystal display devices, and monitors.

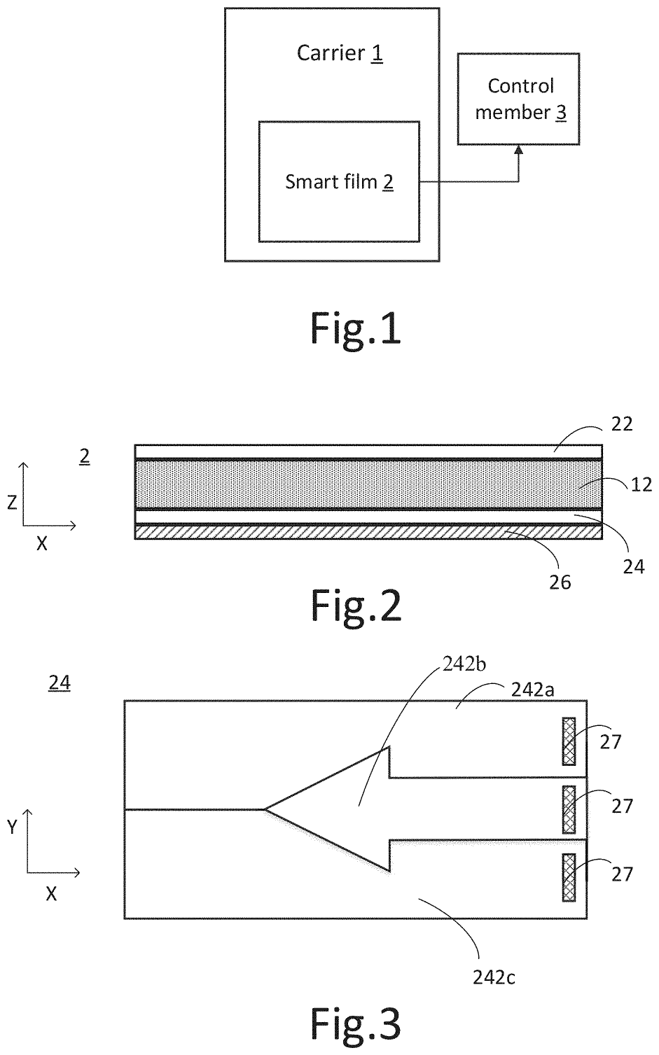

Refer to FIG. 1 and FIG. 2. The smart film apparatus of the present invention includes at least one smart film 2 and a control member 3. The smart film 2 is fixed to a carrier 1 and controlled by the control member 3. The control member 3 is electrically connected with the smart film 2 and outputs phase signals to control the presentation of the smart film 2. In one embodiment, the control member 3 includes active elements, passive elements, circuits and a circuit board. In another embodiment, the control member 3 is integrated with a single controller and related circuits. The smart film 2 includes a liquid crystal layer 12, a first conductive layer 22 and a second conductive layer 24, wherein the first conductive layer 22 and the second conductive layer 24 are disposed on two opposite surfaces of the liquid crystal layer 12. The liquid crystal layer 12 attaches to one surface of the second conductive layer 24, and an adhesive membrane 26 fixedly sticks onto the other surface of the second conductive layer 24. Alternately, the adhesive membrane 26 may stick onto the first conductive layer 22. In one embodiment, the liquid crystal layer 12 includes a polymer dispersed liquid crystal (PDLC) structure or a polymer network liquid crystal (PNLC) structure. The first conductive layer 22 and the second conductive layer 24 are transparent, such as one which is made of a material like inorganic conductive material (metals or metal oxides), organic conductor material, organic or inorganic conductive polymer material, and organic or inorganic semi-conductive polymer material, with the light transmittance over 70%. The material of the first conductive layer 22 and the second conductive layer 24 may be, for example but not limited to, silver, silver nanowire, indium tin oxide(ITO), carbon nanotube-dopping conductive materials, or poly(3,4-ethylenedioxythiophene) (PEDOT). The smart film 2 is essentially a soft component that can be completely stuck onto a plane or curved surface of the carrier 1 through the adhesive membrane 26, wherefore it may be called a smart adhesive membrane. The electric connection between the smart film 2 and the control member 3 is implemented by an appropriate electric connection part, such as copper foil, copper net with silver paste, or a flexible printed circuit (FPC) board with anisotropic conductive film (ACF).

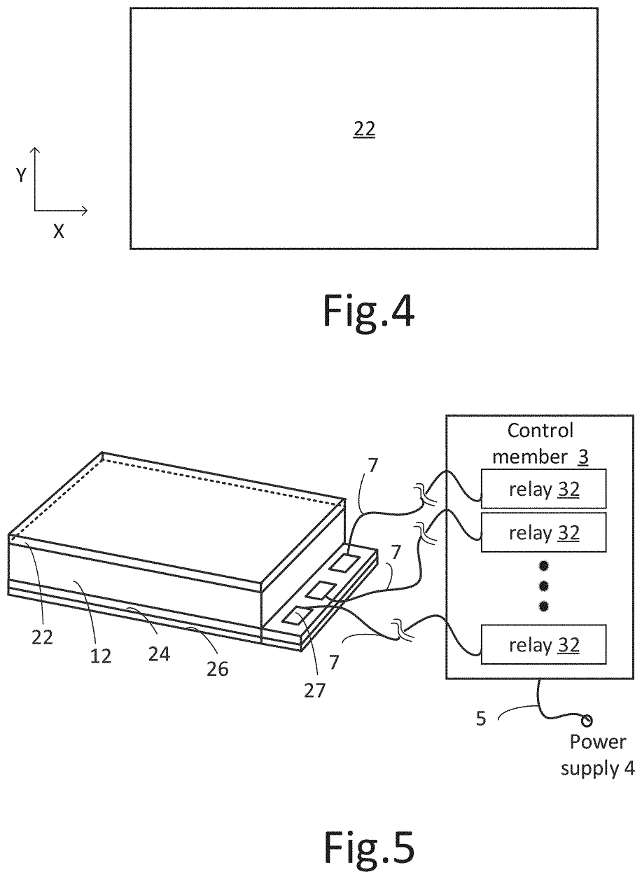

Refer to FIG. 3 and FIG. 4. The conductive layer includes a plurality of conductive units electrically isolated from each other. In one embodiment, the first conductive layer 22 is an integral uncut ITO film in company with the second conductive layer 24 including plenty of second conductive units 242a, 242b and 242c where the second conductive unit 242b is with a theme pattern. Electrodes 27 are respectively formed at the parallel ends of the second conductive units 242a, 242b and 242c in an appropriate method. Phase control signals from the control member 3 travel through the electrodes 27 to the smart film 2 to control the smart film 2 to perform presentation effects. The electrodes 27 are only formed on a single surface of the second conductive layer 24 and slightly protrude from the surface where they exist. Thus, the electrodes 27 may be fabricated in a relatively simple way. The second conductive units 242a, 242b and 242c have essentially identical or similar sizes. Accordingly, the other surface opposite to one where the electrodes 27 exist is a flattened surface.

Refer to FIGS. 1-5. According to the designed presentation effect, the control member 3 outputs positive and negative phase signals and floating/grounding control signals, via the electrodes 27 respectively, to control the second conductive units 242a, 242b and 242c. It is understood that the control member 3 may output variable phase signals sort by time to control any one of the conductive units to increase the presentation effects of the smart film 2. The smart film 2 may have variety of presentation effects, for example, the region corresponding to the second conductive unit 242b is opaque constantly along with that the regions corresponding to the second conductive units 242a and 242c are transparent constantly; the region corresponding to the second conductive unit 242b is transparent constantly along with that the regions corresponding to the second conductive units 242a and 242c are opaque constantly; the regions corresponding to the second conductive units 242a, 242b and 242c are switched to be totally transparent or totally opaque. However, the smart film may also have other presentation effects in addition to the effects mentioned above. Different from the conventional technology, the present invention achieves the functions of controlling spotlighting and presenting specified theme patterns via the positive/negative phase signals together with floating/grounding control signals of the control member 3.

Refer to FIG. 5 again. In the embodiment, plenty of electrodes 27 are all disposed on a single surface of a single conductive layer (such as the second conductive layer 24 or the first conductive layer 22). Each electrode 27 is disposed in the area of a single conductive unit and exposed to the external. The adhesive membrane 26 is attached onto a surface opposite to the surface where the electrodes 27 are disposed. Each electrode 27 is electrically connected with one of relays 32 of the control member 3 through an electric connection structure 7, such as copper foil, copper net with silver paste, or a flexible printed circuit (FPC) board with anisotropic conductive film (ACF). The control member 3 is electrically connected with a power supply 4 through an electric connection structure 5, such as cables or other conventional methods. The power supply 4 may provide alternating current or direct current. In the present invention, the control member 3 outputs positive/negative phase signals (AC signals) through the relays 32 and transmits electric control signals (AC signals) to the second conductive layer 24 through the electric connection structure 7 and the electrodes 27 in the floating/grounding way. The oscillation of the electric signals may influence the first conductive layer 22. In the present invention, the design that the electrodes are disposed on a single surface of the conductive layer may favor the application of the smart film. For example, the smart film where the electrodes are disposed on a single surface may provide a flattened bottom surface without level difference (the other surface of the conductive layer for adhesive installation) to benefit itself to smoothly and compliantly stick to transparent glass in an adhesive way.

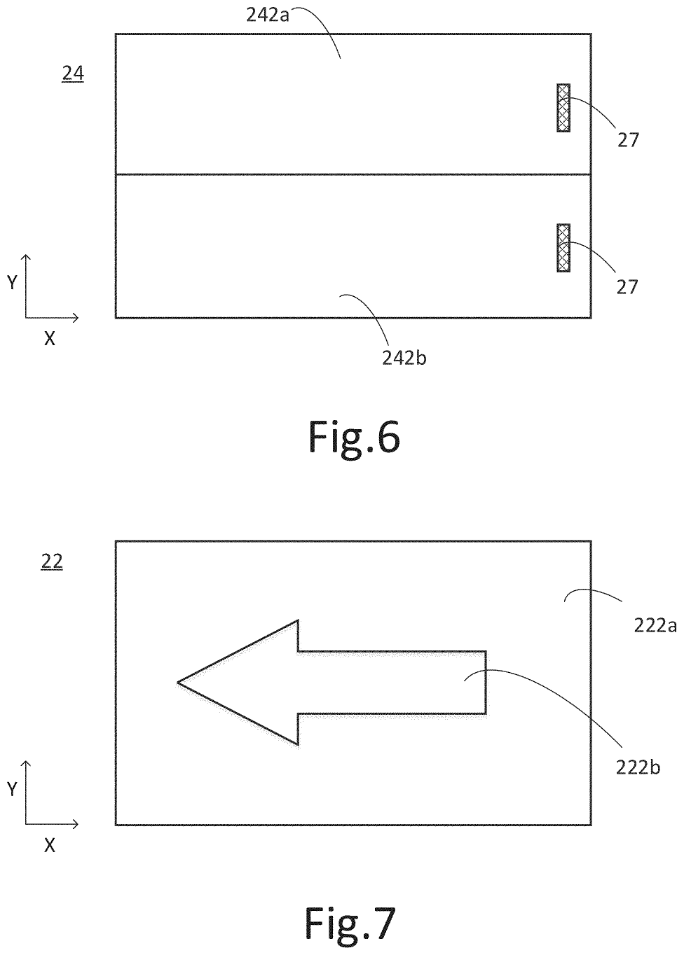

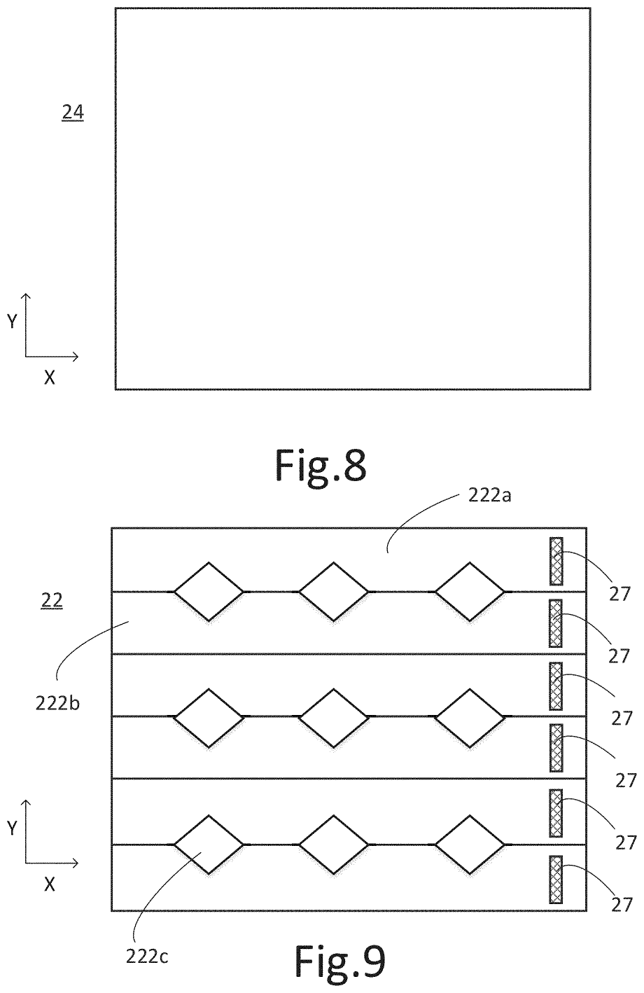

FIG. 6 and FIG. 7 schematically a smart film according to a second embodiment of the present invention. In the second embodiment, the second conductive units 242a and 242b of the second conductive layer 24 are in form of rectangular strips arranged together. An electrode 27 is formed on one end of a single surface of each of the second conductive units 242a and 242b. The first conductive layer 22 includes first conductive units 222a and 222b electrically isolated from each other. The first conductive unit 222a encircles the first conductive unit 222b having a patterned boundary. The first conductive unit 222b is parallel to the second conductive units 242a and 242b. The controlling method of the smart film in the second embodiment is the same as that of the first embodiment and will not repeat herein. FIG. 8 and FIG. 9 schematically a smart film according to a third embodiment of the present invention. In the third embodiment, the whole second conductive layer 24 is an integral plane in companying with the first conductive layer 22 including first conductive units 222a, 222b and 222c which are electrically isolated from each other. Under the control of the control member, the electrically-isolated conductive unit 222c may present an opaque region constantly.

According to embodiments aforementioned, as the electrodes of the smart film apparatus are fixed on a single surface of a single conductive layer, the other surface opposite to the surface where the electrodes are deposited may provide a flattened plane suit for an adhesive membrane and favorable for attaching the smart film apparatus on a carrier. Therefore, the fabrication process of a smart film apparatus is simplified and its application is more convenient. The smart film of the present invention can be applied to a carrier fast and conveniently without worrying the compliance of the smart film onto a carrier.

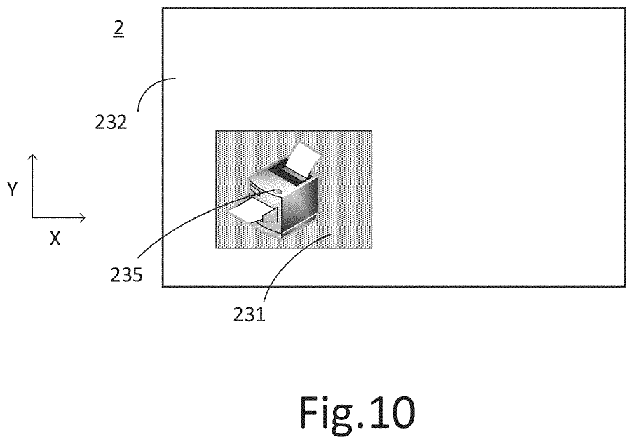

Moreover, under controlling with positive/negative phase signals and floating/grounding control signals, the smart film having electrodes disposed on a single surface may perform various presentation scenarios, such as: the whole upper region or the whole lower region of the smart film is transparent; the transparent regions appear alternately; the transparency of the transparent region varies gradually. Besides, under controlling with positive/negative phase signals and floating/grounding control signals, the smart film having electrodes disposed on two surfaces may have a presentation scenario where the object is opaque and seems to be suspended in air, as shown in FIG. 10.

Refer to FIG. 10. In the embodiment shown in FIG. 10, an arbitrary region may be assigned for presenting a specific effect. For example, a first display unit 231 is assigned as a specific location within the presentation area of the smart film 2, such as the lower left region, and of a specific size, as shown in FIG. 10. The region outside the first display unit 231 but within the presentation area of the smart film 2 may be assigned to as another display unit. For example, the region surrounding the first display unit 231 may be defined as a second display unit 232. The control member 3 may control any one of the first display unit 231 and the second display unit 232 to be transparent or opaque. For example, the first display unit 231 is opaque constantly together with the region surrounding the first display unit 231 (i.e. the second display unit 232) which is transparent constantly. In practical application, the user may use the first display unit 231 as a back panel for projecting images from a projector. Shown in FIG. 10, a content 235 is projected onto the area within the first display unit 231, and the second display unit 232 surrounding the first display unit 231 is transparent enough for the users at one side of the smart film 2 to see through to view objects on the other side of the smart film 2. Besides, a LED monochromatic or full-color project lamp may be used to project light onto the opaque first display unit 231 to be an active light source at night. Different from the conventional technology, the control member 3 adopts the positive/negative phase signal together with the floating/grounding method to controls the smart film to perform the opaque first display unit 231 surrounded by the transparent second display unit 232, and the position and size of the first display unit 231 may be assigned at user's own will.

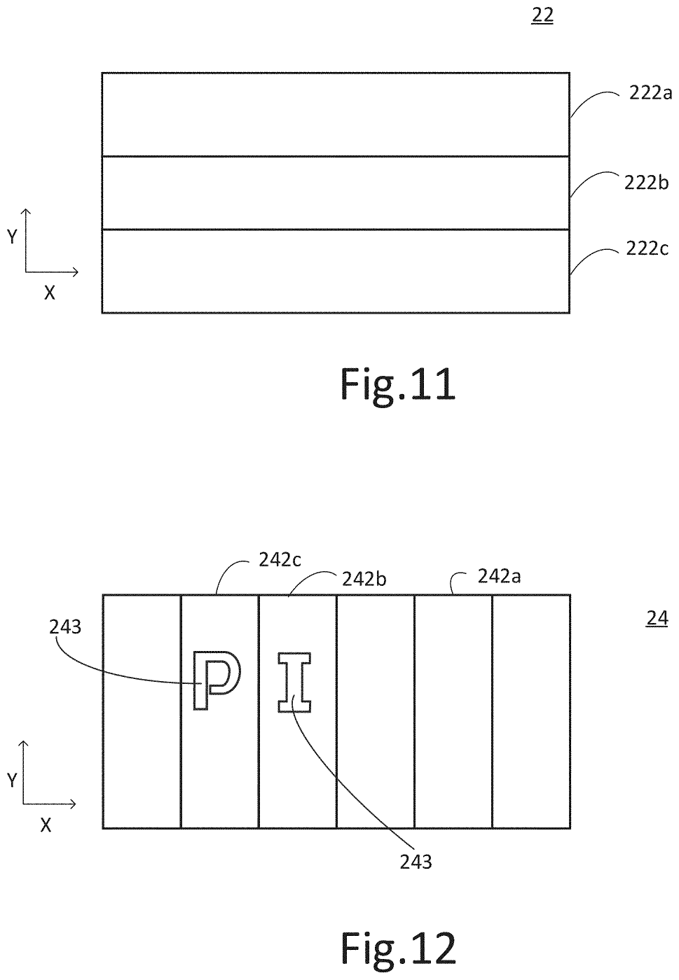

Refer to FIG. 11 and FIG. 12 for a fourth embodiment having a suspended and opaque presentation effect. Refer to FIG. 2 as well as FIG. 11 and FIG. 12, the first conductive units 222a, 222b and 222c of the first conductive layer 22 are in form of rectangular strips parallel to each other. The second conductive units 242a, 242b and 242c are in form of rectangular strips parallel to each other but vertical to the first conductive units 222a, 222b and 222c. At least one theme pattern 243 is formed on one or more of the second conductive units 242a, 242b and 242c. It is noted that the formation of the theme pattern 243 does not block the electric conductivity within the territory of the second conductive units 242a, 242b or 242c. In FIG. 12, the engraved capital letters “P” and “I” are used the theme patterns 234 for example. The areas outside and inside of the engraved “P” are electrically isolated from each other, while anywhere exceptive of area enclosed by the engraved “P” is conductive within the second conductive unit 242c. Similarly, the areas outside and inside of the engraved “I” are electrically isolated from each other, while anywhere exceptive of area enclosed by the engraved “I” is conductive within the second conductive unit 242b. It is understood that the theme pattern 243 may also be formed on the first conductive layer 22. In one embodiment, plenty of theme patterns 243 are formed on the first conductive units 222a, 222b and 222c of the first conductive layer 22 and the second conductive units 242a, 242b or 242c of the second conductive layer 24, respectively. One theme pattern 243 on the first conductive layer 22 may be stacked over another theme pattern 243 on the second conductive layer 24 or does not overlap another theme pattern 243 on the second conductive layer 24. In such a case, the electrodes are respectively formed on the surfaces of the first conductive layer and the second conductive layer (not shown in the drawing), and the details thereof will not repeat herein.

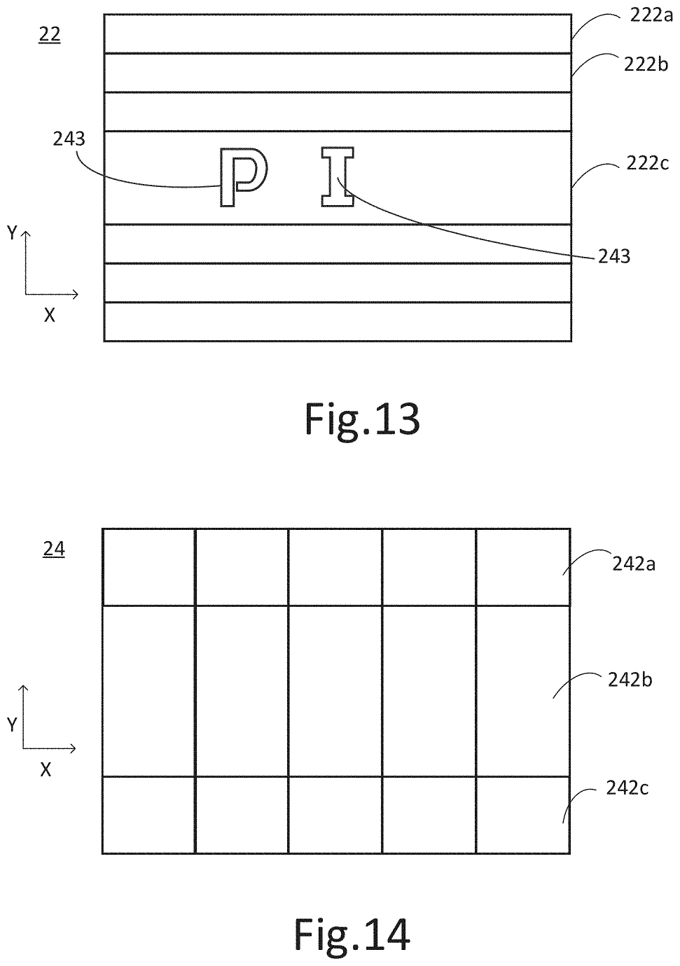

FIG. 13 and FIG. 14 are for a fifth embodiment. In the fifth embodiment, the first conductive units 222a, 222b and 222c of the first conductive layer 22 are in form of rectangles respectively having different widths. For example, in FIG. 13, the first conductive unit 222c is larger than the first conductive units 222a and 222b. Plenty of theme patterns 243 are all formed on the first conductive unit 222c. The first conductive units 222a, 222b and 222c are parallel to each another without interlacing or overlapping. The second conductive units 242a, 242b and 242c of the second conductive layer 24 may also be in form of rectangles respectively having different widths and lengths, as well as arranged parallel and adjacently without interlacing or overlapping. Similarly, at least one electrode (not shown in the drawing) is formed on one side of each of the first conductive units and the second conductive units.

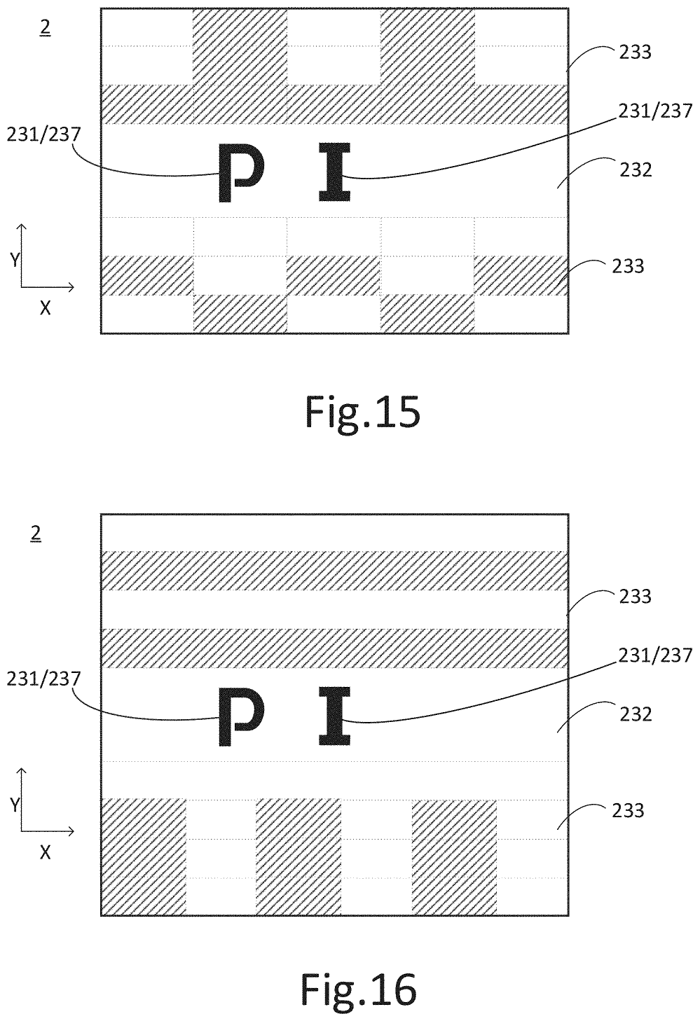

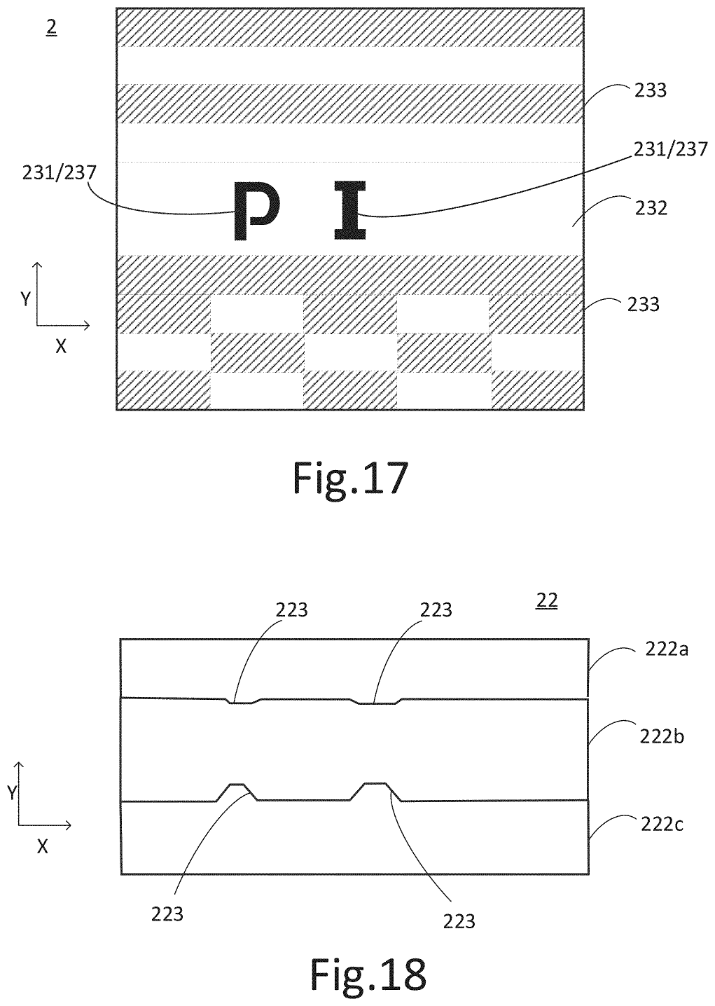

Refer to FIG. 15. FIG. 15 schematically shows a first example of presentation of the fifth embodiment. In the example of FIG. 15, the configurations of the first conductive layer and the second conductive layer of the smart film 2 may be the same as these in FIG. 13 and FIG. 14. In FIG. 15, the shapes of the first conductive units and the second conductive units of the smart film 2 are shown in dotted lines. In the example, a portion of the first conductive units overlap a portion of the second conductive units. The theme patterns 243 are formed on one of the conductive layer 22 and the second conductive layer 24. Via controlling the smart film 2 with positive/negative phase signals together with floating/grounding, the positions and sizes of the contents 237 of the theme patterns 243 are unchanged, and the contents 237 (the first display units 231) are always opaque permanently. Moreover, the second display units 232 surrounding the contents 237 are assigned to be transparent, whereby to achieve a spotlighting presentation of the contents 237 (the first display units 231). Furthermore, the presentation areas outside the second display units 232 are defined as third display units 233 herein. In other words, the second display unit 232 is between the first display unit 231 and the third display unit 233. In one embodiment, the shapes and configuration of the first conductive units and the second conductive units may present a checkerboard-like image of the third conductive units under the control of the control member. The checkerboard-like image and other images can be statically or dynamically presented through the dynamic control of the control member. For example, in FIG. 15, the third display units 233, which are above and below the second display units 232, may be presented statically or dynamically through the dynamic control of the control member. FIG. 16 and FIG. 17 respectively show different presentation effects, but they will not be further described herein. Through the design of the conductive layers, via the positive/negative phase signals in company with the floating/grounding, the present invention can present the opaque contents 237 (the first display units 231), the transparent second display units 232, and the transparent and/or opaque third display units 233.

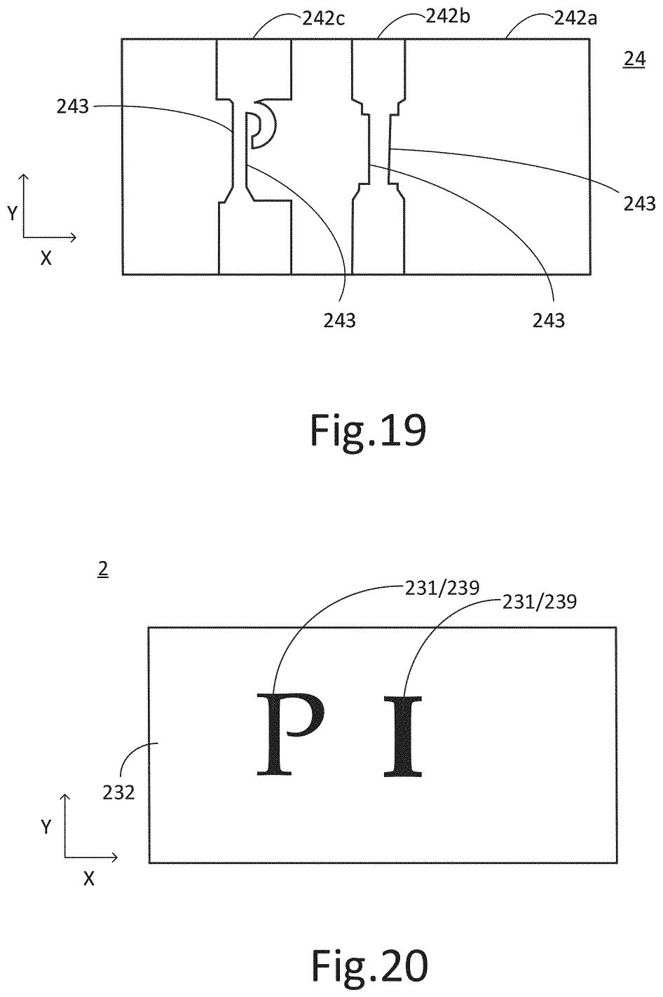

FIG. 18 and FIG. 19 are for a sixth embodiment. In the sixth embodiment, the first conductive units 222a, 222b and 222c of the first conductive layer 22 are in form of strips parallel to each other but respectively having different shapes or contours. Similarly, the second conductive units 242a, 242b or 242c of the second conductive layer 24 are in form of strips vertical to the first conductive units 222a, 222b and 222c but respectively have different shapes or contours. In the sixth embodiment, one or more first theme patterns 223 are formed on the borders between two neighboring first conductive units 222a, 222b and 222c; one or more second theme patterns 243 are formed on the borders between two neighboring second conductive units, wherein the positions of the first theme patterns 223 coordinate with the positions of the second theme patterns 243. It is understood that two theme patterns respectively positioned at the border of one conductive unit and inside the area of the conductive unit may be formed on the same conductive layer.

FIG. 20 shows an image presented by the smart film 2 containing the first conductive layer 22 and the second conductive layer 24 shown in FIG. 18 and FIG. 19, which is controlled by the positive/negative phase signals in a floating/grounding method. Refer to FIG. 18, FIG. 19 and FIG. 20. In this embodiment, the first theme pattern 223 and the second theme pattern 243 are respectively formed on the first conductive layer 22 and the second conductive layer 24 and coordinate with each other. The positions and sizes of the contents 239, which the first theme pattern 223 and the second theme pattern 243 cooperate to present, are unchanged. Each of the contents 239 is formed by arranging the first theme pattern 223 and the second theme pattern 243 in superimposing relationship in view of vertical projection. In this embodiment, the areas of first display units 231 is righty the areas of the contents 239. Next, the first theme pattern 223 and the second theme pattern 243 are formed on the borders of the first conductive units or the second conductive units. Therefore, the contents 239 may be controlled to be transparent or opaque. The second display unit 232 around the contents 239 may also be controlled to be transparent or opaque. Thus, the contents 239 may be controlled to be opaque, and the second display unit 232 may be controlled to be transparent, whereby to emphasize the contents 239. Furthermore, in the case of the smart film apparatus including a polymer network liquid crystal (PNLC), both the contents 239 (the first display units 231) and the second display unit 232 are controlled to be transparent at first, and then the second display unit 232 is controlled to become opaque instantaneously, whereby to emphasize the transparent contents 239 in another presentation effect. Hence, in the present invention, the control member may control the second display unit around the contents to be transparent in a floating/grounding control method.

Accordingly, the smart film with double-side electrodes may present opaque first display units and transparent second display units around the first display units under the controlling of the positive/negative phase signals together with floating/grounding control signals, so that the opaque first display units may use as the background for additional images while viewer may see surrounding environment through the transparent second display units without influence. The smart film apparatus of the present invention may be integrated with a 3D display device available in the market, whereby 2D text or pictures may be presented in a local region of the 3D images.

The embodiments described above are to demonstrate the technical thoughts and characteristics of the present invention and enable the persons skilled in the art to understand, make, and use the present invention. However, these embodiments are not intended to limit the scope of the present invention. Any equivalent modification or variation according to the spirit of the present invention is to be also included by the scope of the present invention.

What is claimed is:

1. A smart film apparatus, comprising:
a smart film including a first conductive layer, a second conductive layer and a dispersed liquid crystal layer disposed between the first conductive layer and the second conductive layer, the first conductive layer and the second conductive layer including multitude of conductive units electrically isolated from each other, wherein there are a plurality of electrodes are exposed on a single surface of the first conductive layer or the second conductive layer, and the electrodes are fixedly on a portion of the conductive units; and
a control member electrically connected to the electrodes and outputting multitude of control signals for controlling the first conductive layer or the second conductive layer where the electrodes are, and the control signals include at least one floating or grounding control signal.

2. The smart film apparatus according to claim 1 further comprising an adhesive membrane fixedly onto anther surface opposite to the surface where the electrodes are, wherein the smart film is stuck onto a carrier by the adhesive membrane.

3. The smart film apparatus according to claim 1, wherein the control member includes a plurality of relays respectively electrically connected with the electrodes.

4. The smart film apparatus according to claim 3, wherein the relays output positive/negative signals and the floating/grounding control signals.

5. The smart film apparatus according to claim 1, wherein a material of the first conductive layer or the second conductive layer includes indium tin oxide, poly(3,4-ethylenedioxythiophene) (PEDOT) or silver nanowire.

6. The smart film apparatus according to claim 1, wherein the dispersed liquid crystal layer is a polymer dispersed liquid crystal (PDLC) layer, a polymer network liquid crystal (PNLC) layer, or a bistable cholesteric liquid crystal (BiCh-LC) layer.

7. The smart film apparatus according to claim 1 further comprising copper foil, copper net with silver paste, or a flexible printed circuit (FPC) board with anisotropic conductive film (ACF) for electrically connecting the electrodes.

8. A smart film apparatus, comprising:
a smart film including a first conductive layer, a second conductive layer and a dispersed liquid crystal layer disposed between the first conductive layer and the second conductive layer, the first conductive layer including a plurality of first conductive units electrically isolated from each other, the second conductive layer including a plurality of second conductive units electrically isolated from each ether; and
a control member electrically connected with the first conductive layer and the second conductive layer and outputting a plurality of control signals for controlling the first conductive units and the second conductive units, wherein the control signals at least includes a floating or grounding control signal to make the smart film present an opaque first display unit and a transparent second display unit adjacent to the first display unit.

9. The smart film apparatus according to claim 8, wherein the smart film further includes a theme pattern positioned at one of the first conductive units or one of the second conductive units, and the first conductive unit or the second conductive unit inside an outline of the theme pattern is electrically isolated from the first conductive unit or the second conductive unit outside the outline of the theme pattern.

10. The smart film apparatus according to claim 9, wherein the theme pattern is controlled by the control member to present itself as the first display unit within one of the first conductive units or one of the second conductive unit.

11. The smart film apparatus according to claim 8, wherein the smart film further includes a first theme pattern formed on a border of two neighboring first conductive units and a second theme pattern formed on a border of two neighboring second conductive units, and the first theme pattern and the second theme pattern are controlled by the control member to present as the first display units.

12. The smart film apparatus according to claim 8, wherein the first conductive units are parallel to each other and the second conductive units are parallel to each other, and the first conductive units and the second conductive units are arranged in an interlacing relationship, an overlapping relationship, or an interlacing-overlapping relationship.

13. The smart film apparatus according to claim 8, wherein one or more first geometrical shapes of the first conductive units are identical, or, one or more second geometrical shapes of the second conductive units are identical, and the first conductive units and the second conductive units are arranged in an interlacing relationship, an overlapping relationship, or an interlacing-overlapping relationship.

14. The smart film apparatus according to claim 8, wherein the control signals include at least one of positive phase control signals and negative phase control signals.

15. The smart film apparatus according to claim 8 further comprising a projecting image to be projected onto the first display unit.

16. A smart film apparatus, comprising;
a smart film including a first conductive layer, a second conductive layer and a dispersed liquid crystal layer disposed between the first conductive layer and the second conductive layer, wherein the first conductive layer includes a plurality of first conductive units electrically isolated from each other, and the second conductive layer includes a plurality of second conductive units electrically isolated from each ether; and
a control member, electrically connected with the first conductive layer and the second conductive layer and outputting a plurality of control signals to control the first conductive units and the second conductive units, wherein the control signals includes a floating/grounding control signal, a positive electric signal and a negative electric control signal to control a presentation effect of the smart film.
